(19) United States
(12) Patent Application Publication
(10) Pub. No.: US 2026/0030543 A1
(43) Pub. Date: Jan. 29, 2026

(54) DYNAMIC NOVELTY LEARNING FRAMEWORK FOR INCREASING ROBUSTNESS OF ANOMALY DETECTION

(71) Applicant: Dell Products L.P., Round Rock, TX (US)

(72) Inventors: Leandro Takeshi Hattori, Campo Grande (BR); Luiz Fernando Sommaggio Coletta, Rio Claro (BR); Victor da Cruz Ferreira, Rio de Janeiro (BR); Vinicius Facco Rodrigues, São Paulo (BR)

(21) Appl. No.: 18/784,265

(22) Filed: Jul. 25, 2024

(51) Int. Cl. G06N 20/00

(52) U.S. Cl. CPC G06N 20/00

(57) ABSTRACT

A dynamic novelty learning framework is disclosed. The ability of an anomaly detection system to adapt to changes in data distributions is dynamically adapted. When samples or data points are deemed anomalous, the samples are added to an anomaly cluster pool. Over time, anomaly clusters develop in the anomaly cluster pool. When an anomaly cluster fulfill aspects or tests that are indicative of normality, the anomaly cluster is transitioned to be a normality cluster and subsequent samples are evaluated using existing normality clusters and the new normality cluster. This allows the anomaly detection system to dynamically adapt to data drift, learn new normal distributions and prevent or reduce the rate at which normal samples are erroneously identified as anomalous.

### TECHNOLOGICAL FIELD OF THE DISCLOSURE

Embodiments disclosed herein generally relate to anomaly detection in data, applications, and computing systems and environments. More particularly, at least some embodiments relate to systems, hardware, software, computer-readable media, and methods for performing anomaly detection while adapting to data drift and performing novelty detection.

### BACKGROUND

Anomaly detection (AD) is increasingly becoming a significant part of computing infrastructure. Anomaly detection can increase system robustness and mitigate issues associated with detected anomalies. For example, a wide variety of systems and operations from online sales logs to server observability may be monitored for anomalies. The ability to effectively detect and address anomalies improve the performance of services and servers. The improvement may be reflected in improved customer satisfaction. In addition, detecting anomalies can reduce the impact of the anomalies on client computing systems and services.

Anomaly detection systems are often standalone solutions that build a model to learn a standard distribution that is pertinent to the relevant use case. The model is thus capable of identifying data points that deviate from normal based on the learned or standard distribution. Generally, data points are compared against some type of threshold and, when the error or distance exceeds the threshold, an anomaly alert may be generated for the anomalous data points.

However, computing systems and operating environments found in industry today are dynamic and complex. These computing systems experience concept drift over time. The concept drift leads to changes in the normal data distribution. This makes it difficult for a fixed trained model to perform well in the long term at least because the current data distribution has drifted or changed relative to the learned data distribution. The model is thus likely to identify normal or valid data points as anomalous data points.

Stated differently, changes in the data distribution may represent novel standard behavior (novelties) that may be confused with or identified as anomalies by fixed models. To mitigate the occurrence of this erroneously detecting anomalies, the demanding tasks of performance monitoring and frequent retraining/updating of the model are required. However, while performing retraining/updating tasks, the system experiences a decrease in performance and downtimes.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of an anomaly detection system configured to perform anomaly detection operations while dynamically adapting to at least data drift;

FIG. 2A discloses aspects of selecting normality clusters for analyzing an input sample;

FIG. 2B discloses aspects of anomaly detection operations in an anomaly detection system;

FIG. 2C discloses aspects of inserting an anomalous sample into an anomaly cluster pool;

FIG. 2D discloses aspects of novelty detection in an anomaly detection system;

FIG. 2E discloses aspects of determining a frequency over time aspect of anomalous samples during novelty detection;

FIG. 2F discloses aspects of pseudocode for determining whether a frequency over time aspect is true or false

FIG. 3 discloses aspects of anomaly detection operations performed in an anomaly detection system; and

FIG. 4 discloses aspects of a computing device, system, or entity.

### DETAILED DESCRIPTION OF SOME EXAMPLE EMBODIMENTS

Embodiments disclosed herein generally relate to anomaly detection. More particularly, at least some embodiments relate to systems, hardware, software, computer-readable media, and methods for dynamically adapting an anomaly detection system over time to reduce or avoid degradation in the anomaly detection system.

Embodiments of the invention are discussed in the context of anomaly detection. Embodiments may be applied, however, to dynamically adapting computing systems to improve learning without complete retraining and to dynamically learn new data distributions that are normal or valid. As used herein and by way of example, novelty or novelties may refer to data that is no longer anomalous, but is normal or valid. Novelty or novelties may also refer to operations performed to determine that samples previously identified an anomalous are now normal. Embodiments of the invention are discussed in the context of samples or data points. A data point is an example of a sample. A data point or sample may be a discrete datum, a set of data, a data stream, or the like or combinations thereof.

The anomaly detection system is dynamically adapted by identifying and learning novelties, which may include new data distributions. As previously stated, the samples evaluated in a given system may experience drift over time and embodiments of the invention are able to adapt to data drift.

In one example, it is possible that the initial training dataset may not include all normality space distributions. Embodiments of the invention advantageously relate to a dynamic and self-configurable anomaly detection system that can learn distributions of new normal regions. Examples of the novelty detection engine can adapt to changes or novelties in the data distribution and adapt over time to changes in the operating environment.

Generally, anomaly detection is configured to identify patterns (e.g., in samples) that diverge from normal patterns. Normal samples conform with expected behavior while abnormal samples may indicate irregularity or anomalies.

An anomaly detection system may include models configured to predict or determine whether a sample is normal or anomalous. In one example, autoencoders, which do not require labels for each class, are used. An autoencoder can be trained to minimize the reconstruction error of the non-anomalous data. Thus, the autoencoder is trained with non-anomalous data. If the model tries to reconstruct data outside of the expected patterns (anomalous data), the reconstruction error will be higher than the error for non-anomalous data. Autoencoders advantageously enable unsupervised anomaly detection.

Novelty detection relates to discovering patterns (novelties) that deviate from existing known patterns. Embodiments of the invention dynamically adapt an anomaly detection system to novelties by clustering samples determined to by anomalous. More specifically, a novelty starts as an anomaly data point that deviates from an established data distribution. When this behavior occurs frequently, it is possible to encounter distributions that were not anticipated or covered during training phase of the models included in the anomaly detection system. In the context of anomaly detection, novelty detection approaches can reduce false positive rates in an unsupervised manner by allowing the system to adapt to changes in data distributions.

Samples can be determined to be anomalies from various perspectives. Embodiments of the invention are discussed in the context of autoencoders. However, probabilistic approaches such as Gaussian mixture models, hidden Markov models, or Bayesian networks may be used to estimate the probability distribution of data and identify deviations.

A reconstruction error can be used to determine whether a sample is anomalous. A sample may be considered to be anomalous (i.e., when the sample does not fit into any known pattern/class) by observing the reconstruction error of an autoencoder. More specifically, the training dataset of non-anomalous samples may be clustered into normality clusters. When a sample does not comport any of the clusters and is deeded anomalous by selected models, the sample may be anomalous.

Embodiments of anomaly detection may also include aspects of unsupervised clustering, which can aid in identifying patterns in large datasets where high dimensionality and large sample numbers make the data difficult to analyze. Clustering may include operations to find, identify or group samples that share similar features or characteristics. This allows the input or training dataset to be segmented or separated into normality clusters. Each of the normality clusters is associated with some number of samples.

Each of the normality clusters may represent different patterns and allows relationships and proximity to be clarified or determined. Example clustering algorithms include DBSCAN (Density-Based Spatial Clustering of Applications with Noise), K-Means, and different Hierarchical clustering algorithms. These example clustering algorithms consider a (dis) similarity metric to measure how close data points are to each other to form data clusters in a way to minimize a cost function (a combinatorial optimization may be performed). The metrics commonly used may be a Euclidian distance, Manhattan distance, or cosine similarity. Typically, each cluster can be represented by a centroid, i.e., the (average) sample that characterizes the information contained in the cluster.

Embodiments of the invention relate to maintaining the quality of an anomaly detection system in the presence of, by way of example only, data drift and/or novelty emergence. The ability of the anomaly detection system to automatically adapt to changes and uncertainties in the data distribution allows the quality and performance of the anomaly detection system to be maintained.

Embodiments of the invention relate to an anomaly detection system that is capable of disentangling new observed standard behaviors (novelties) from anomalies. This allows the anomaly detection system to expand its knowledge or learning over time. This makes the anomaly detection system (and its models) resilient to data drift and provides an anomaly detection system that has a better understanding of the environment. Embodiments of the invention advantageously minimizes or reduces downtime (e.g., due to model retraining), performance reduction, and false positives. Thus, degradation of the anomaly detection system is reduced or prevented. Further, the knowledge of the anomaly detection system is improved and better mapped to the environment over time. Because the knowledge of the anomaly detection system grows over time, the anomaly detection system becomes more robust over time.

A learnable anomaly detection framework is disclosed that is configured to learn novelties. The novelties are incorporated as new (non-anomalous) behaviors thereby decreasing the likelihood of false positives due to the anomaly detection system being outdated.

By way of the example, the anomaly detection system or framework includes a normality cluster pool, a set of anomaly detection models, and an anomaly cluster pool. The normality cluster pool is initialized offline with only non-anomalous samples. This allows multiple normality clusters representing different non-anomalous data distributions or patterns to be created or generated. Each cluster may have a centroid as a representative sample for that cluster.

Each cluster in the normality cluster pool is associated with an anomaly detection model trained to identify anomalies within that cluster. For example, an autoencoder can be trained to reconstruct samples for a specific cluster. A high reconstruction error may trigger an anomaly for that autoencoder, indicating that the sample does not exhibit normal/standard behavior. The cluster centroid is used as a key or reference to link the models and the clusters.

In one example, all incoming samples are evaluated to determine a distance relative to the centroids of all normality clusters in a normality cluster pool. An approach based on k nearest neighbors may be used to select specific normality clusters. Usually, at least one centroid (or cluster) is selected, even if the distance is too large. Based on the selected centroids, the incoming samples are passed through the anomaly detection models corresponding to the selected centroids (or selected clusters). When all of the selected anomaly detection models determine that an incoming sample is an anomaly, the anomaly detection system may generate an alarm that an anomaly was detected. The incoming sample may also be saved in the anomaly cluster pool.

The anomaly cluster pool thus contains samples that are identified as anomalies by the selected models. In one example, the anomaly cluster pool is empty when initialized. For each new anomalous sample, a new cluster is created or the new anomalous sample is added to a current anomaly cluster. More specifically, in one example, the new anomalous sample is added to a nearest or closes anomaly cluster.

An anomaly cluster may, at some point, exhibit characteristics of a novelty. When this occurs, the samples in the anomaly cluster are no longer considered to be anomalies. As a result, the anomaly cluster is removed from the anomaly cluster pool and added to the normality cluster pool as a new normality cluster. A new anomaly detection model (e.g., an autoencoder) is trained using the instances or samples in the new normality cluster and a centroid for the new cluster is determined.

A novelty detector is configured to assess anomaly clusters to verify whether the anomaly clusters represent novelties. Over time, these components of the anomaly detection system allow the system to expand its learning, account for data drift and reduce false positives.

The anomaly detection system or framework includes normality and anomaly clusters and anomaly detection models. The anomaly detection system can avoid or reduce degradation and interruptions by dynamically self-adapting to concept drift and by self-adapting to unmapped data distribution in this framework.

A first cluster pool (the normality cluster pool) contains standard samples and a second cluster pool (the anomaly cluster pool) includes anomalous samples. The normality cluster pool is improved with novelties (e.g., new normality clusters) by separating or disentangling the novelties from the anomalies in the anomaly cluster pool. When an anomaly cluster is promoted or transferred to the normality cluster pool, a new anomaly detection model is trained and incorporated into the model pool of the anomaly detection system. This allows the system to be self-updated with current data trends and patterns, which ensures the continued effectiveness of the anomaly detection system over time.

Embodiments of the invention use the centroids of each normal cluster as a key to identify the models to use for anomaly detection. Embodiments of the invention use the output of selected models when checking whether a sample is anomalous. This uses, in effect, a crowd approach (multiple models) and may generate a more reliable determination about whether a sample is anomalous. Using multiple anomaly detection models provides a more diverse verification even though the models are representative of a specific region around the sample being evaluated. Using multiple models allows the anomaly detection system to deal with different standard or normal patterns. Embodiments of the invention improve the robustness of an anomaly detection system by adding novelties to the normality cluster pool, thereby incorporating a more complete distribution space and accounting for concept drift.

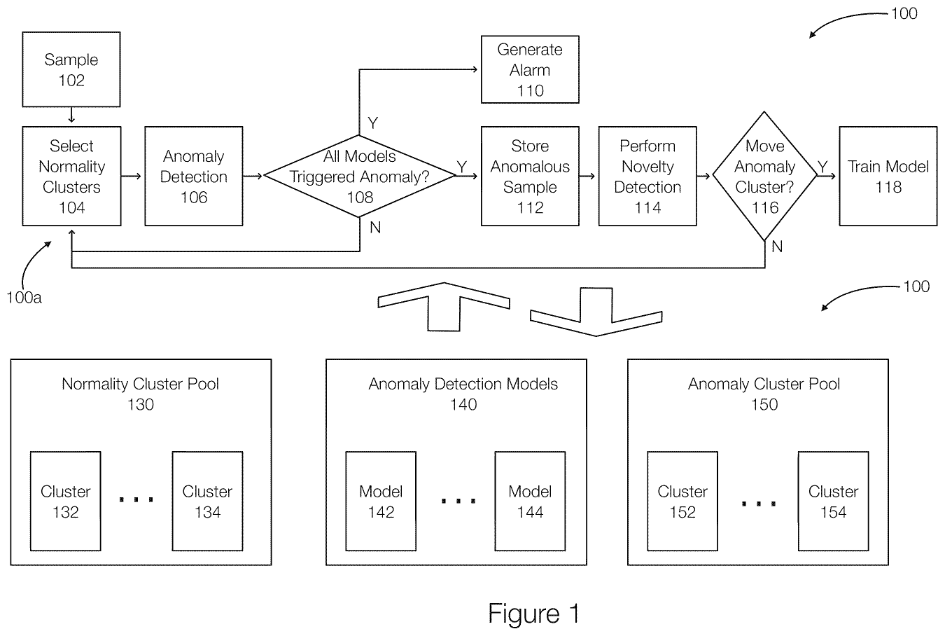

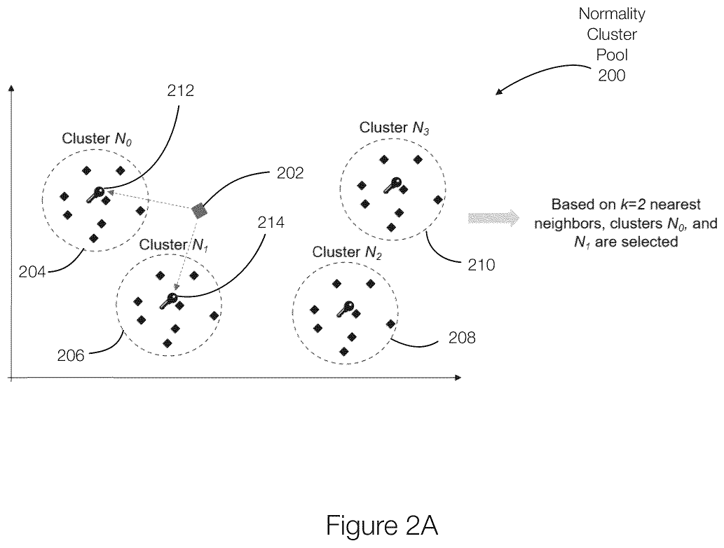

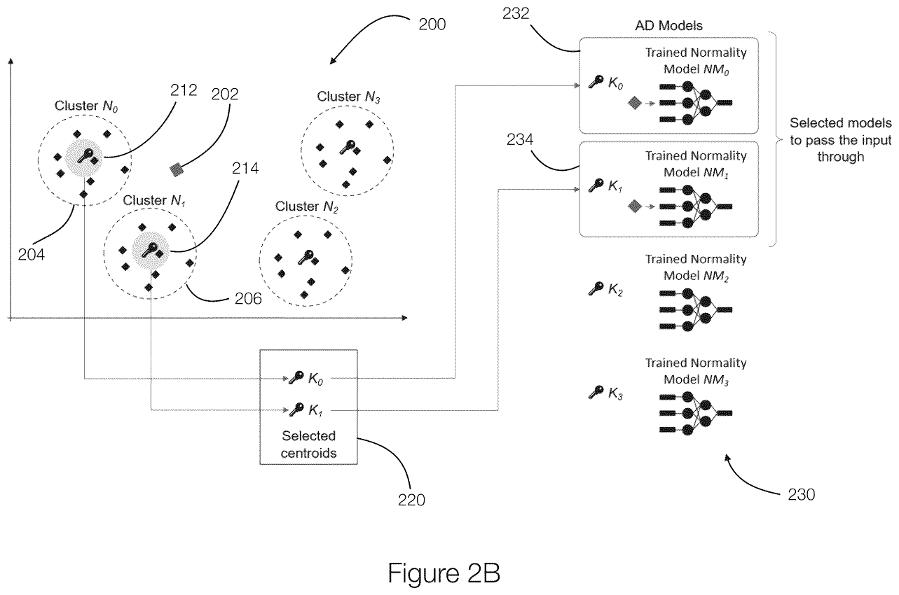

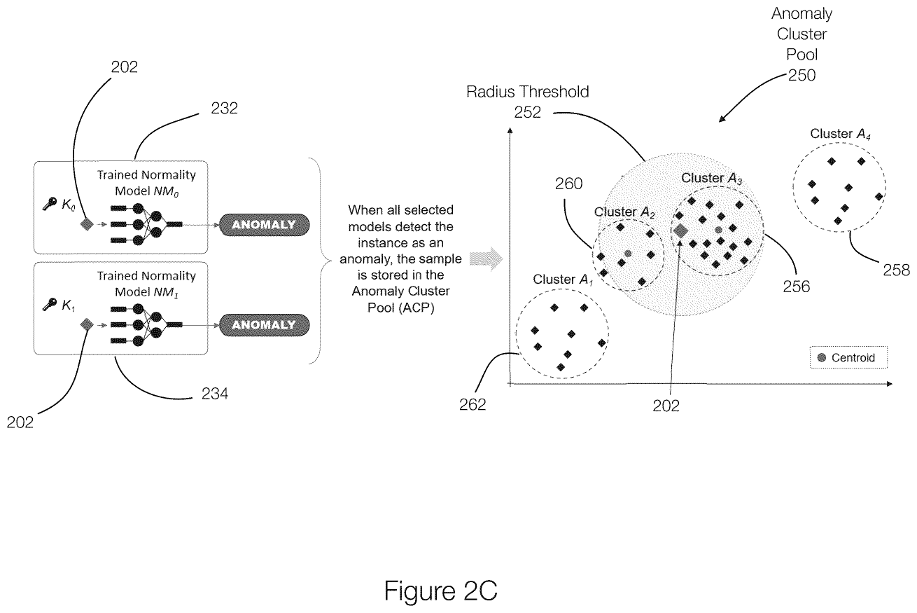

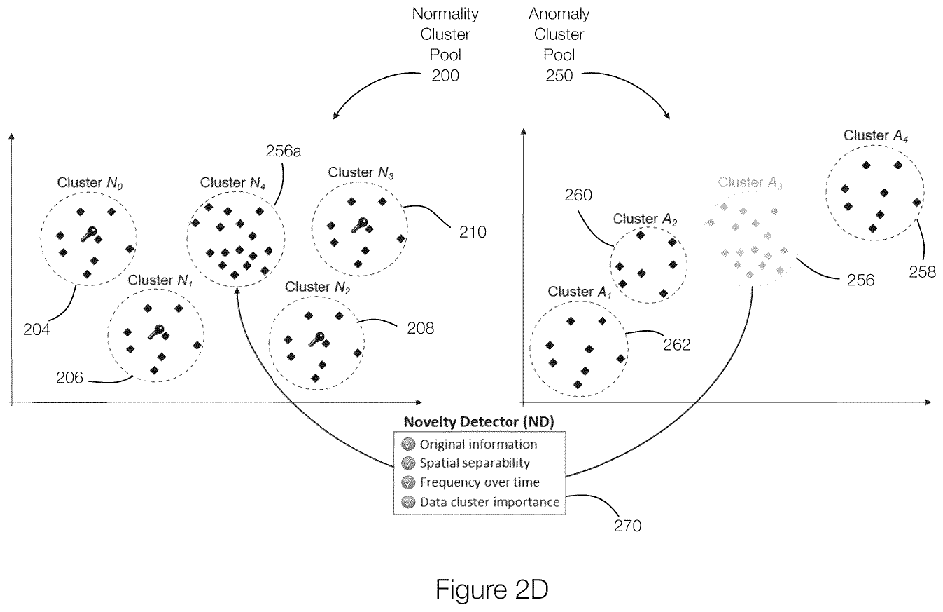

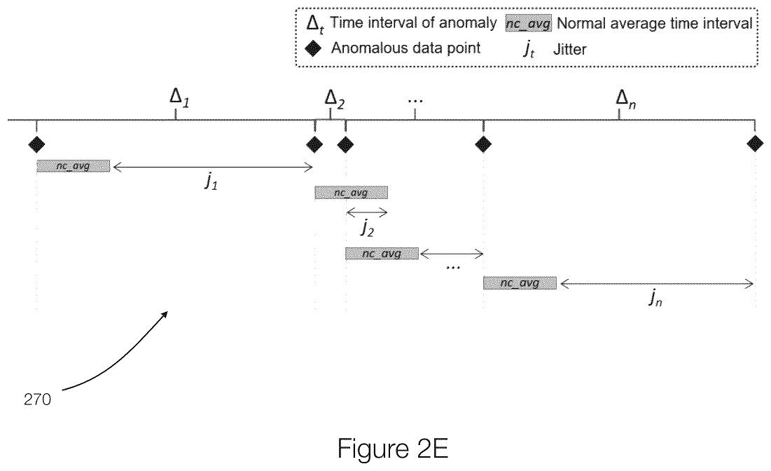

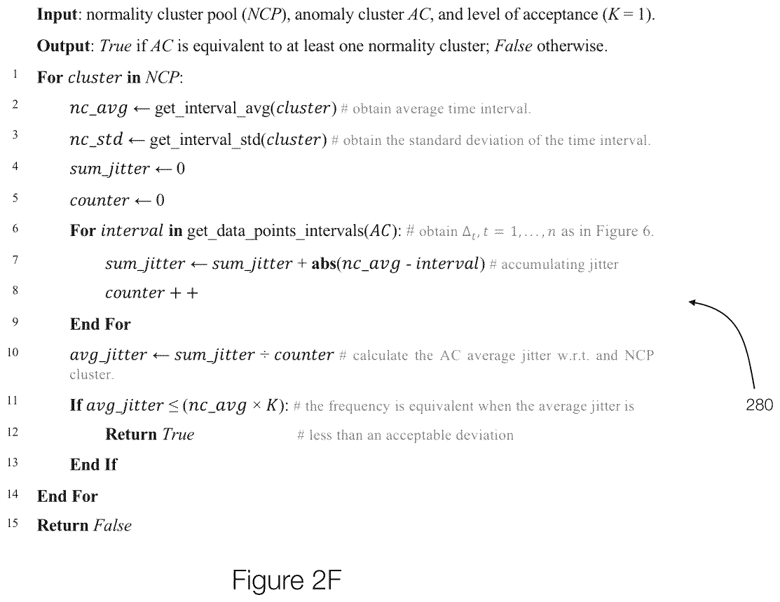

FIG. 1 discloses aspects of an anomaly detection system configured to perform anomaly detection operations. FIGS. 2A-2F discloses further aspects of the anomaly detection system and anomaly detection operations.

In FIG. 1, the anomaly detection system 100 is associated with or includes a normality cluster pool 130. The normality cluster pool 130 includes clusters represented by clusters 132 and 134. The clusters 132 and 134 are initialized or generated using non-anomalous samples (or data points). In one example, a dataset of non-anomalous samples is clustered using unsupervised clustering operations in one example to generate or create the clusters 132 and 134. Each of the clusters 132 and 134 includes a centroid that is a representative sample for the corresponding cluster even if the centroid does not correspond to an actual sample.

The anomaly detection system 100 is also associated with anomaly detection models 140, which are represented by the models 142 and 144. In this example, the model 142 is associated with the cluster 132 and the model 144 is associated with the cluster 134. Thus, each normality cluster in the normality cluster pool 130 is associated with a corresponding model.

The model 142 is trained to identify anomalies within or with respect to a space or distribution represented by the cluster 132. For example, the model 142 may be an autoencoder configured to reconstruct a sample. When a sample input to the model 142 is associated with a high reconstruction error (e.g., greater than a threshold error), the sample is deemed to be anomalous with respect to the corresponding model/cluster.

The anomaly detection system 100 is also associated with an anomaly cluster pool 150, which is represented by the clusters 152 and 154. When the anomaly detection system is initially deployed or initialized, the anomaly cluster pool 150 may be empty. Samples are added to the anomaly cluster pool 150 and clustered as the samples are evaluated by the anomaly detection system in one example.

For example, if all of the models 142 and 144 determine that an input sample (e.g., the sample 102) is anomalous, the sample 102 is added to the anomaly cluster pool 150 and clustered. Thus, each new anomalous sample is added to the anomaly cluster pool 150 by creating a new cluster or adding to an existing anomaly cluster.

The method 100a is an example anomaly detection method that may be performed by the anomaly detection system 100. The method 100a may be performed partially, wholly, or the like. Further some portions of the method 100a may operate periodically. The method 100a assumes that the normality cluster pool 130, the anomaly detection models 140, and the anomaly cluster pool 150 have been prepared or initialized.

In this example, a sample 102 is received into the anomaly detection system 100. Based the sample 102, normality clusters are selected as illustrated in FIG. 2A.

FIG. 2A discloses aspects of selecting normality clusters for analyzing an input sample and/or based on an input sample. FIG. 2A illustrates a normality cluster pool 200, which is an example of the normality cluster pool 130. The normality cluster pool 200 includes normality clusters 204, 206, 208, and 210. The cluster 204 includes or is associated with a key 212 (centroid of the cluster). The other clusters 206, 208, and 210 are associated with or include a centroid (e.g., key to identify a corresponding anomaly detection model).

Selecting normality clusters (104 in FIG. 1) includes selecting clusters that are representative of an input sample 202 (e.g., the sample 102). The keys of the selected clusters are used to identify the corresponding anomaly detection models. More specifically, the sample 202 (or other input data) is preprocessed into features that can be drawn, by way of example only, according to various key performance indicators (KPIs). Thus, the anomaly detection system may execute in a multivariate context.

Thus, the normality clusters in the normality cluster pool 200 are kept in the same feature space. Thus, the sample 202, which may be represented as a feature vector in this space, may be compared against diverse normal data represented by the normality clusters 204, 206, 208, and 210.

In this example, the sample 202 is evaluated against the clusters 204, 206, 208 and 210 the normality cluster pool 200. The key 212, in one example, is an average vector (or centroid) of the samples included in the cluster 204. Thus, the sample 202 can be compared against each of the keys of the clusters 204, 206, 208, and 210.

More specifically, the clusters in the normality cluster pool 200 may be initialized offline using clustering operations operating on a dataset with only non-anomalous data. The number of clusters can be specified.

In this example, the cluster selection process selects k nearest neighbors to the sample 202. In this example, k=2, but k may be any other number. The nearest neighbor clusters may be based on the keys or centroids. Thus, a distance metric in the space (e.g., a Euclidean distance) may be used to select the k nearest clusters to the sample 202. In this example, k is a parameter that can be adjusted by the user, so that low values will favor a local specific exploitation of the presence of an anomaly, while higher values will provide a more general analysis of anomalies.

The centroids or keys of the selected clusters are used to access or identify corresponding models for anomaly classification. In this example, the clusters 204 and 206 are the nearest neighbor normality clusters to the sample 202 and the keys 212 and 214 are used to access specific models included in the anomaly detection models 140.

Returning to FIG. 1, anomaly detection 106 is performed after selecting normality clusters 104 from the normality cluster pool. FIG. 2B discloses aspects of anomaly detection operations in an anomaly detection system. FIG. 2B, for k=2, illustrates that clusters 204 and 206 have been selected as the nearest neighbors to the sample 202. The centroids or keys 212 and 214 of these clusters 204 and 206 may be used to identify the associated models. In this example, the model 232 is associated with the cluster 204 and the model 234 is associated with the cluster 206.

The sample 202 is input to the models 232 and 234. The output of the models 232 and 234 determines whether the sample is an anomalous sample. For example, in the case of an autoencoder, the sample 202 is determined to be anomalous when the reconstruction error is above a threshold error.

Generally, the sample 202 is determined to be anomalous when all of the selected models 232 and 234 individually determine that the sample 202 is anomalous. In one example, if all models did not trigger an anomaly (N at 108), the sample is sufficiently similar to samples in one of the selected clusters and the method 100a may continue with a next sample. Although not shown, samples that are not determined to be anomalous may be stored and used for other purposes such as retraining or the like as necessary.

If the selected models all triggered an anomaly (Y at 108), an alarm or alert may be generated 110. In addition, the anomalous sample is stored 112 in the anomaly cluster pool 150.

FIG. 2C discloses aspects of storing or inserting an anomalous sample into the anomaly cluster pool. FIG. 2C illustrates that the sample 202 is determined to be anomalous by all of the selected models 232 and 234. Thus, the sample is inserted or stored in the anomaly cluster pool 250. In this example, various anomalous clusters 256, 258, 260, and 262 exist in the anomaly cluster pool 250. The samples or data stored in the anomaly cluster pool 250 may include or represent diverse types or patterns and are not associated with anomaly detection models.

When adding an anomalous sample, such as the sample 202, to the anomaly cluster pool 250, a radius threshold 252 is used to determine whether the sample 202 is added to an existing cluster or whether a new cluster is created. The radius threshold 252 is associated with the sample 202 in one example.

The radius threshold 252 may be based on the size of the normality clusters. For example, the radius size may rely on the size of the normality clusters measured by a distance metric (e.g., Euclidean distance). More specifically, the average radius size of the normality clusters may be set as the radius threshold 252 in the anomaly cluster pool 250. Other metrics may be used. For example, the radius threshold 252 may be based on minimum or maximum sizes of the normality clusters. In another example, a scaling factor (%) may be adopted, weighing a selected size from those presented above (average, minimum, or maximum from clusters in NCP).

In one example, the radius threshold 252 may overlap with existing clusters. In FIG. 2C, the radius threshold 252 overlaps with the anomaly clusters 256 and 260. In this example, the sample 202 is placed with the anomaly cluster whose centroid is closest. Once added, the centroid is updated. If none of the anomaly clusters overlap with the radius threshold 252, a new cluster that includes the sample 202 is formed. Because anomalous samples are, in most cases, less likely to occur than non-anomalous samples, the centroid recalculation is not expected to be a burden.

By setting the radius threshold 252 in a manner that relates to the normality clusters, the anomaly clusters are formed to be like or similar to the normality clusters at least in terms of size. This may be useful when trying to determine whether an anomaly cluster is actual a novelty or representative of a new normal or standard pattern.

Once the sample 202 is placed or stored in the anomaly cluster pool 250 (in this example, the sample was associated with the cluster 256), novelty detection is performed 114.

FIG. 2D discloses aspects of novelty detection in an anomaly detection system. More specifically, FIG. 2D discloses aspects of improving the robustness of the anomaly detection system by adding a new cluster to the normality cluster pool 200 from the anomaly cluster pool 250. More specifically, after the insertion of an anomalous sample into the anomaly cluster pool 250, novelty detection is performed to determine whether any samples or anomaly clusters should be transferred to the normality cluster pool. Novelty detection may also be performed at a different schedule (e.g., after a predetermined number of sample insertions into the anomaly cluster pool 250).

The anomalous samples inserted into the anomaly cluster pool 250 generate clusters whose properties and characteristics become more evident over time and as additional samples are added. Novelty detection explores these properties in order to disentangle new (standard) behavior or pattern from anomalies. This helps prevent the anomaly detection engine from being deceived by false positives caused by data drift and helps the anomaly detection system maintain performance over time in the face of data drift.

As previously suggested, a novelty may represent a new standard or acceptable behavior/pattern. It may also represent an increase in the space in which anomalies are being detected. In this example, the addition of the sample to the anomaly cluster 256 and subsequent novelty detection operation determines that the anomaly cluster 256 represents a novelty. Once this is determined, the anomaly cluster 256 is removed from the anomaly cluster pool 250 and moved to the normality cluster pool 200 as a normality cluster 256a.

Generally, novelties are initially introduced to the anomaly detection system as anomalies. Due to their repeated or continuous recurrence, these anomalies may eventually be seen as non-anomalous samples and represent patterns that the anomaly detection system should learn in order to improve and maintain performance efficiency. The normality cluster pool 200 and the anomaly cluster pool 250 represent a dual-cluster organization that allows both anomalous and non-anomalous samples to be tracked concurrently. This allows telemetry to be generated that can be evaluated in order to better learn what is normal and what is anomalous.

FIG. 2D illustrates a novelty detector 270 that enables clusters to be transferred from the anomaly cluster pool 250 to the normality cluster pool 200 when various circumstances or aspects are fulfilled. In one example, clusters are transferred when certain tests are all satisfied, although other thresholds may be set (e.g., a certain percentage of tests are satisfied).

In this example, the novelty detector 270 considers tests or aspects of the samples/clusters in the anomaly cluster pool 250 related to (i) original information, (ii) spatial separability, (iii) frequency over time, and (iv) data cluster importance.

The originality of information aspect suggests that the instances in the anomaly cluster 256 being considered represent a new pattern or class that is distinct from the clusters in the normality cluster pool 200. Generally, this is true because each instance or sample added to the anomaly cluster pool 250 are deemed to be anomalies with respect to the normality cluster pool 200 (or at least the selected clusters, which are the nearest neighbors). As a result, in this example, the anomaly clusters 256, 258, 260, and 262 all satisfy this requirement. Thus, or originality of information aspect for the anomaly cluster 256 being considered is 1 or true (Aₒᵣᵢ=1).

Another aspect is spatial separability. Because novelty detection may insert at least one of the anomaly clusters into the normality cluster pool 200, the anomaly cluster being inserted or added should avoid overlapping with normality clusters already present in the normality cluster pool 200. In one example, a Silhouette index may be used to determine whether the anomaly cluster being considered overlaps with existing normality clusters.

For example, for a given instance or sample j belonging to an anomaly cluster in the anomaly cluster pool 250 (anomaly cluster p) a distance aₚⱼ (e.g., Euclidean, Manhattan) to its centroid is determined. Similarly, the distance from this same instance or sample to the centroid of the nearest normality cluster is bₚⱼ is determined. The Silhouette can be computed as:

$${s}_{pj} = \frac{{b}_{pj} - {a}_{pj}}{max \{ {b}_{pj} , {a}_{pj} \}}$$

Assuming the above calculation for all |p| instances within the anomaly cluster p, the average Silhouette of this cluster is determined as follows:

$${S}_{p} = \frac{1}{\vert p \vert} {\sum }_{j = 1}^{\vert p \vert} {s}_{pj}$$

In one example, a rule is applied over Sₚ to produce a binary answer for the spatial separability aspect (Aₛₑₚ):

$${A}_{sep} = \{ \begin{matrix}0 , & If {S}_{p} < threshold \\ 1 , & otherwise\end{matrix} .$$

In one example, the threshold in the above rule can be, for example, 0.7. The closer the Silhouette is to 1.0, the better the relationship between the cohesion of the analyzed cluster and its separability from the other clusters (e.g., the clusters in the normality cluster pool 200).

Another aspect is a frequency over time aspect (A_{fre}). An example characteristic of a normal pattern or class is its periodicity. When related samples are generated at a regular interval of time, this suggest that the instances or samples are normal rather than anomalous. Thus, anomalous samples that begin to exhibit periodicity like normal samples are more likely to be novelties at least because authentic anomalies do not maintain a regularity of occurrence.

To verify the frequency over time aspect, jitter may be used. Jitter may reflect or indicate how much a periodic signal deviates from a real (normal) assumed periodicity. FIG. 2E illustrates a graph 270. More specifically, FIG. 2E shows the occurrence of samples (or data points) from an anomaly cluster in anomaly cluster pool 250. As illustrated in the graph 270, the time intervals Δₜ between sample occurrence are irregular, which elevates the (average) jitter if the jitter is computed against a fixed average time interval (nc_avg) as a target. The average time interval can be obtained, for example, from instances of a normality cluster. Embodiments of the invention check the correspondence of frequencies between a normal behavior (e.g., using the normality clusters) and an anomaly cluster to confirm it is a novelty. Thus, low jitter indicates anomalous samples are being generated at a frequency similar to the frequency at which normal samples are generated. Jitter can assist in determining whether anomalous samples or instances are interpreted as normal or anomalous.

The average jitter of n time intervals can be determined for each of the normality clusters in the normality cluster pool. In one example, when the average jitter of an anomaly cluster is less than a standard deviation of the time intervals of a normality cluster, the anomaly cluster is positive (True or 1) for this aspect.

FIG. 2F discloses aspects of pseudocode for determining whether a frequency over time aspect is true or false (1 or 0). FIG. 2F illustrates pseudocode 280 that determines whether the frequency over time aspect (A_{fre}) for an anomaly cluster is true or false or (1 or 0).

The next aspect evaluated during novelty detection is a data cluster importance aspect. This aspect relates anomaly clusters that exhibit representativity like existing normality clusters. In one example, the importance of an anomaly cluster may be measured based on its size and/or volume. Counting the number of instances in the anomaly cluster is an example of measuring this aspect. Anomaly clusters having larger numbers of samples are more likely to be normal rather than anomalous.

In order to favor clusters whose size and/or volume are equivalent to or similar to the size and/or volume of existing normality clusters, a binary rule may be used to determine whether a cluster satisfies the data cluster importance aspect.

The data cluster importance aspect may be determined as follows:

$${A}_{i m p} = \{ \begin{matrix}1 , & ( {μ}_{size}^{NCP} - K {σ}_{size}^{NCP} ) \leq {C}_{size}^{ACP} , \\ 0 , & otherwise .\end{matrix}$$

where

$${μ}_{size}^{NCP} and {σ}_{size}^{NCP}$$

refer to the mean and standard deviation of measured sizes of normality clusters, respectively.

$${C}_{size}^{ACP}$$

is the size or the anomaly cluster under analysis, and K=[0, 3] is the standard deviation range, which implies the level of acceptance of the cluster.

In one example, performing 114 novelty detection evaluates aspects, such as original information aspect, spatial separability aspect, frequency over time aspect, and data cluster importance aspect, to determine whether an anomaly cluster should be moved to the normality cluster pool and become a normality cluster. In one example, the following equation is computed:

$$N D ( Normality Detection ) = {A}_{ori} \times {A}_{sep} \times {A}_{fre} \times {A}_{imp}$$

If ND=1 (Yes), the anomaly cluster being analyzed is moved to the normality cluster pool. Thus, one or more aspects may be evaluated or tested to disentangle a novelty from anomalies in the anomaly cluster pol and adapt the anomaly detection system over time to previously unknown or unlearned distributions.

Returning to FIG. 1, if the anomaly cluster being analyzed does not satisfy all required aspects (N at 116), the next sample is evaluated. If the anomaly cluster satisfies all four aspects, (Y at 116), the anomaly cluster is moved to or transferred to the normality cluster pool and a model is trained 118 and associated to the new normality cluster. When subsequent samples are received, the sample is evaluated using the updated normality cluster pool. This allows the anomaly detection system to account for data drift over time, avoids complete retraining and reduces false positives.

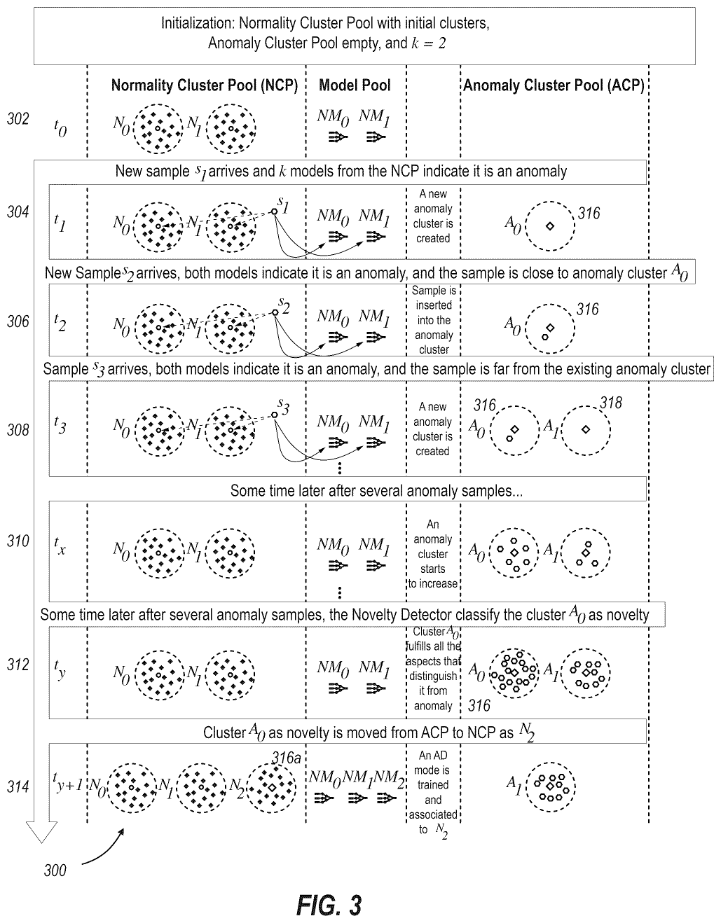

FIG. 3 discloses aspects of anomaly detection operations performed in an anomaly detection system. FIG. 3 illustrates states of the normality cluster pool and the anomaly cluster pool at different points in time of a workflow 300. At time t₀, the anomaly detection system is initialized at state 302. The initialization of the anomaly protection system may be performed offline. During initialization, the normality clusters are generated for the normality cluster pool using a dataset of non-anomalous data. In this example, k=2. Models are trained and associated with each of the normality clusters in the normality cluster pool. The anomaly cluster pool is initially empty and does not include any anomaly clusters at initialization in one example.

The initialization state 302 sets a foundation for a non-anomalous distribution, defines the initial models and clusters that determine the initial behavior of the anomaly detection system.

As state 304 or t₁, a new sample or data point (s₁) is received by the anomaly detection system. The data point is preprocessed (e.g., feature determination) and compared against the normality clusters in the normality cluster pool. For example, a distance from the new sample to centroids of the normality clusters may be determined. This allows the nearest neighbors to be selected. In this example, the data point (s₁) is determined to be an anomaly. As a result, a new anomaly cluster is created in the anomaly cluster pool. The anomaly cluster includes data point (s₁).

More specifically, normality clusters are selected (e.g., n nearest neighbors) and the models corresponding to the selected normality clusters all indicate that the data point (s₁) is an anomaly. An alert is generated, and a new anomaly cluster is generated.

At state 306 or time t₂, a data point (s₂) is received. A similar process is performed and, in this example, the data point (s₂) is determined to be anomalous. The data point (s₂) is inserted into the previously created anomaly cluster 316 because the radius threshold of the data point (s₂) overlaps the anomaly cluster 316.

At state 308 or time t₃, a data point (s₃) is received. The data point (s₃) is also determined to be anomalous following a similar procedure. However, a radius threshold of the data point (s₃) does not overlap with any other anomaly clusters in the anomaly cluster pool. As a result, the data point (s₃) is added to a new anomaly cluster 318.

The state 310 or time tₓ represents that many data points have been added to the anomaly cluster pool. The state 310 also illustrates that the sizes/volumes of the anomaly clusters are increasing.

After each data point insertion into the anomaly cluster pool, novelty detection is typically performed to determine whether any of the anomaly clusters can transition into normality clusters. This transition is performed when an anomaly cluster satisfies aspects or tests indicating that the anomaly cluster represents a new standard, normality, or novelty.

At state 312 or time t_{y}, the anomaly cluster 316 is being promoted or is transitioned to be a normality cluster. The anomaly cluster 316 fulfills all aspects that distinguish anomalies from normal or standard behavior. At time t_{y+1}, the cluster 316 is transitioned to be a normality cluster 316a and is included in the normality cluster pool. A corresponding model is trained and included in the model pool. Subsequently received data points are thus evaluated in light of the newly added normality cluster 316a. This expands the scope and space of the anomaly detection system, reduces the occurrence of false positives, and the like.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, clustering operations, anomaly detection operations, adaptive learning operations, operations for transitioning anomalous data to normal data, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘sample’, ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a sample as input to an anomaly detection system, selecting normality clusters from a normality cluster pool based on the sample, performing anomaly detection using selected models that correspond to the selected normality clusters, when all of the selected models indicate that the sample is anomalous, inserting the sample into an anomaly cluster pool, performing novelty detection on anomaly clusters in the anomaly cluster pool, and transferring an anomaly cluster from the anomaly cluster pool to the normality cluster pool when the anomaly cluster is a novelty.

Embodiment 2. The method of embodiment 1, further comprising selecting k nearest neighbor normality clusters in the normality cluster pool based on a distance metric, wherein the distance metric is a relationship between the sample and centroids of the normality clusters.

Embodiment 3. The method of embodiment 1 and/or 2, wherein the selected models are autoencoders, wherein the sample is anomalous when a reconstruction error is larger than a threshold error.

Embodiment 4. The method of embodiment 1, 2, and/or 3, wherein performing novelty detection includes determining an originality of information aspect, a spatial separability aspect, a frequency over time aspect, and a data cluster importance aspect for at least one of the anomaly clusters.

Embodiment 5. The method of embodiment 1, 2, 3, and/or 4, wherein the originality of information aspect is satisfied when the selected models indicate that samples are anomalous.

Embodiment 6. The method of embodiment 1, 2, 3, 4, and/or 5, wherein the spatial separability aspect is satisfied when a Silhouette value is greater than a threshold value.

Embodiment 7. The method of embodiment 1, 2, 3, 4, 5, and/or 6, wherein the frequency over time is satisfied when a jitter is below a threshold jitter.

Embodiment 8. The method of embodiment 1, 2, 3, 4, 5, 6, and/or 7, wherein the data cluster importance aspect is satisfied when a size and/or volume of the anomaly cluster is within a threshold range, wherein the threshold range is related to a mean and average deviation of measures sizes of the normality clusters.

Embodiment 9. The method of embodiment 1, 2, 3, 4, 5, 6, 7, and/or 8, wherein the sample is added to an anomaly cluster that overlaps a threshold radius of the sample or a new anomaly cluster is created for the sample when none of the anomaly clusters overlap with the threshold radius of the sample.

Embodiment 10. The method of embodiment 1, 2, 3, 4, 5, 6, 7, 8, and/or 9, further comprising initializing the normality cluster pool by clustering non-anomalous samples, wherein the anomaly cluster pool is empty on initialization, wherein the sample comprises a data point.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

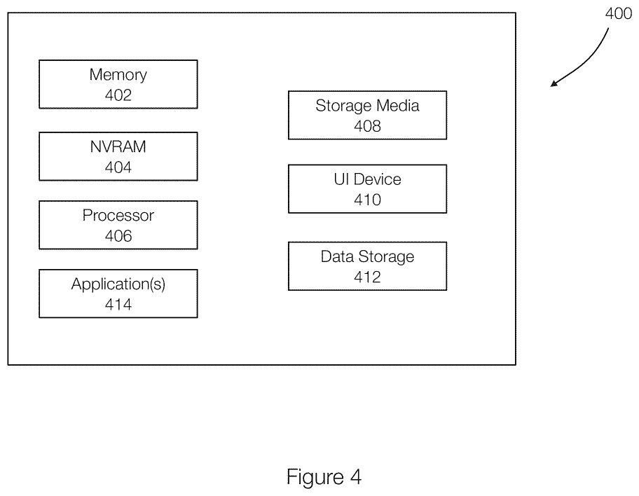

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual or physical.

The described embodiments are to be considered in all respects only as illustrative and not restrictive. All changes which come within the meaning and range of equivalency of the claims are to be embraced within their scope.

What is claimed is:

1. A method comprising:
receiving a sample as input to an anomaly detection system;
selecting normality clusters from a normality cluster pool based on the sample;
performing anomaly detection using selected models that correspond to the selected normality clusters;
when all of the selected models indicate that the sample is anomalous, inserting the sample into an anomaly cluster pool;
performing novelty detection on anomaly clusters in the anomaly cluster pool; and
transferring an anomaly cluster from the anomaly cluster pool to the normality cluster pool when the anomaly cluster is a novelty.

2. The method of claim 1, further comprising selecting k nearest neighbor normality clusters in the normality cluster pool based on a distance metric, wherein the distance metric is a relationship between the sample and centroids of the normality clusters.

3. The method of claim 1, wherein the selected models are autoencoders, wherein the sample is anomalous when a reconstruction error is larger than a threshold error.

4. The method of claim 1, wherein performing novelty detection includes determining an originality of information aspect, a spatial separability aspect, a frequency over time aspect, and a data cluster importance aspect for at least one of the anomaly clusters.

5. The method of claim 4, wherein the originality of information aspect is satisfied when the selected models indicate that samples are anomalous.

6. The method of claim 4, wherein the spatial separability aspect is satisfied when a Silhouette value is greater than a threshold value.

7. The method of claim 4, wherein the frequency over time is satisfied when a jitter is below a threshold jitter.

8. The method of claim 4, wherein the data cluster importance aspect is satisfied when a size and/or volume of the anomaly cluster is within a threshold range, wherein the threshold range is related to a mean and average deviation of measures sizes of the normality clusters.

9. The method of claim 1, wherein the sample is added to an anomaly cluster that overlaps a threshold radius of the sample or a new anomaly cluster is created for the sample when none of the anomaly clusters overlap with the threshold radius of the sample.

10. The method of claim 1, further comprising initializing the normality cluster pool by clustering non-anomalous samples, wherein the anomaly cluster pool is empty on initialization, wherein the sample comprises a data point.

11. A non-transitory storage medium having stored therein instructions that are executable by one or more hardware processors to perform operations comprising:
receiving a sample as input to an anomaly detection system;
selecting normality clusters from a normality cluster pool based on the sample;
performing anomaly detection using selected models that correspond to the selected normality clusters;
when all of the selected models indicate that the sample is anomalous, inserting the sample into an anomaly cluster pool;
performing novelty detection on anomaly clusters in the anomaly cluster pool; and
transferring an anomaly cluster from the anomaly cluster pool to the normality cluster pool when the anomaly cluster is a novelty.

12. The non-transitory storage medium of claim 11, further comprising selecting k nearest neighbor normality clusters in the normality cluster pool based on a distance metric, wherein the distance metric is a relationship between the sample and centroids of the normality clusters.

13. The non-transitory storage medium of claim 11, wherein the selected models are autoencoders, wherein the sample is anomalous when a reconstruction error is larger than a threshold error.

14. The non-transitory storage medium of claim 11, wherein performing novelty detection includes determining an originality of information aspect, a spatial separability aspect, a frequency over time aspect, and a data cluster importance aspect for at least one of the anomaly clusters.

15. The non-transitory storage medium of claim 14, wherein the originality of information aspect is satisfied when the selected models indicate that samples are anomalous.

16. The non-transitory storage medium of claim 14, wherein the spatial separability aspect is satisfied when a Silhouette value is greater than a threshold value.

17. The non-transitory storage medium of claim 14, wherein the frequency over time is satisfied when a jitter is below a threshold jitter.

18. The non-transitory storage medium of claim 14, wherein the data cluster importance aspect is satisfied when a size and/or volume of the anomaly cluster is within a threshold range, wherein the threshold range is related to a mean and average deviation of measures sizes of the normality clusters.

19. The non-transitory storage medium of claim 11, wherein the sample is added to an anomaly cluster that overlaps a threshold radius of the sample or a new anomaly cluster is created for the sample when none of the anomaly clusters overlap with the threshold radius of the sample.

20. The non-transitory storage medium of claim 11, further comprising initializing the normality cluster pool by clustering non-anomalous samples, wherein the anomaly cluster pool is empty on initialization, wherein the sample comprises a data point.
